(19) United States
(12) Patent Application Publication
(10) Pub. No.: US 2023/0279659 A1
(43) Pub. Date: Sep. 7, 2023

(54) Insulated Engineered Structural Member

(71) Applicant: Shawn Patrick KELLEY, Bethesda, MD (US)

(72) Inventor: Shawn Patrick KELLEY, Bethesda, MD (US)

(21) Appl. No.: 18/196,299

(22) Filed: May 11, 2023

Related U.S. Application Data
(63) Continuation-in-part of application No. 17/457,591, filed on Dec. 3, 2021.

(51) Int. Cl. E04B 1/78; E04C 3/14; B29C 44/12

(52) U.S. Cl. CPC E04B 1/78; E04C 3/14; B29C 44/128; B29L 2031/10

(57) ABSTRACT

An engineered structural member for use as, for example a stud, and a method for producing an engineered structural member. The method includes placing two spaced-apart flange members, preferably from nominal dimension solid lumber, in a mold cavity, inserting a two-part mixture of polyurethane material between the flange members, closing the mold and applying pressure to density the two-part polyurethane material during curing, and removing the completed engineered structural member from the mold. Preferably, the multiple engineered structural members are produced in multiple mold cavities, either sequentially, for example, on a rotary molding machine, or simultaneously, for example, in a series of molds which are filled and closed together. The engineered structural member provides increased insulation capacity to a structure while reducing structure weight, improving strength and improving dimensional instability.

### CROSS REFERENCE TO RELATED APPLICATIONS

This application is a continuation-in-part of U.S. application Ser. No. 17/457,591, filed on Dec. 3, 2021, the disclosure of which is expressly incorporated by reference herein.

The present invention relates to the design and utilization of structures, in particular structural members used in building construction.

### BACKGROUND OF THE INVENTION

Historically, the construction of structures such as walls and partitions in a building such as a house has been accomplished by assembling a frame having vertical members (“studs”) attached to horizontal header (aka, top plate) and footer members. Monolithic sawn wood of industry-standardized nominal dimensions frequently has been used for framing walls (for example, a nominal “2×4” piece of lumber has nominal dimensions of 1.5 inches by 3.5 inches, and a “2×6” piece of lumber has nominal dimensions of 1.5 inches by 5.5 inches). Typically the larger dimension has been arranged perpendicular to the planar surfaces of the wall. The surface of the wall facing inward toward the space defined by the wall typically is sheathed in a continuous sheet material, such as drywall or a paneling material, as is well known in the art.

Because the framing members are conventionally solid wood, the passage of utilities such as plumbing pipes, electrical conduits, network cabling, etc. has required substantial builder effort to drill passages through the relatively thick and dense wood of every vertical member of the wall in the case of utility runs parallel to the floor, and through often double-thickness header and footer members in the case of utility runs between floors. The tooling and labor required to create these multiple apertures in the vertical and horizontal directions substantially increases costs and slows construction.

The conventional approach to building such walls also has the disadvantage of creating thermal “bridging” paths between one side of the wall and the opposite side. Wood structural members typically have relatively poor insulation values. As a result the locations on the surface of the wall directly in front of the vertical studs and the header and footer are pathways for heat transfer, effectively bypassing any inter-wall insulation placed inside the wall between the studs. These localized areas can significantly reduce the effective insulation value of the entire wall. For example, in a situation where the wall is intended to provide insulation between a warm living space and a colder outside environment, “cold spots” or “cold corners” may be discerned where the wood framing members allow passage of heat from the inside to the outside environment and is a drain on natural resources.

Another disadvantage of the conventional solid-wood framing approach is that it is resource-intensive, i.e., the volume of the increasingly costly solid wood members required for construction of a wall is relatively large relative to the loads carried by the wood members.

These and other disadvantages are addressed by the insulated structural member of the present invention. In this engineered structural member, substantially less solid wood is needed, and insulating material may be added to provide resistance to heat transfer between the inner and outer surfaces of the wall into which the engineered structural member is incorporated.

In one embodiment of a 2×6 member, a conventional solid 2×4 is rip-cut along its longitudinal centerline, resulting in two narrower length wood flange sections. Each of these cut flanges are provided with a longitudinal slot in their 1.5″ wide faces, sized to receive a relatively rigid thin sheet of material. This “web” member in turn is sized such that when the slots in the flanges are located over the opposite edges of the thin sheet, the overall width of the composite structural member is 5.5″ wide, i.e., a “2×6” is generated. Preferably, the web material is formed from cost-stable web material with superior moisture resistance as compared to osb and plywood, and uses recycled material (for example, 94% post-consumer recycled content & fibers).

The present invention's structural member accordingly uses substantially less solid wood, with commensurate reduction in the cost and weight of the engineered “2×6” (on the order of 40% less by volume and 60% less by weight in a 2×6 embodiment, depending on the moisture content of the wood), and reduces the demand for harvesting natural resources.

The thermal conductivity of the structural member in the 5.5″ direction is reduced by the insulating effect of the very small heat conduction cross-section of the thin sheet web between the slots. The insulation effect is enhanced by including foam insulation in the recesses between the opposing wood flanges on one or both sides of the web. The foam insulation reduces both radiant heat transfer from one wood flange to the other, and radiant and convective heat transfer to the engineered 2×6 structural member from the interior space between adjacent engineered 2×6 structural member of the wall. The foam also acts to prevent thermal bridging of fasteners used to secure exterior sheathing and cladding.

In addition to the cost and material reductions associated with the inventive engineered structural member itself, the present invention may reduce in-situ labor costs by presenting only a relatively thin and easily penetrated web for an installer to cut through when passing utility runs through the wall. This would be the case with both horizontal utility runs and vertical utility runs through headers and/or sill plates arranged with their web sections parallel to the floor.

The engineered structural member also has the advantage of being lighter, stronger and more dimensionally stable than solid lumber (i.e., less susceptible to twisting, warping and shrinking), despite having a smaller cross sectional area. This stability may help minimize “nail pops,” where nail heads are pushed out above the surface of a drywall sheet. In addition, the additional load capacity may enable design of lighter, less costly structures (for example, by allowing greater spacing of vertical members, or the use of smaller-dimensioned headers and/or footers). The present approach may also minimize the effect of “thermal bridging” through fasteners that occur with solid lumber use with exterior rigid foam and sheathing installations.

Depending on the overall insulation effectiveness of a structure built from the present invention's engineered structural member, it may be possible to meet prescriptive energy code requirements for continuous insulation and fenestration values that are not achievable using solid wood framing members, and eliminate the need for expensive exterior rigid foam insulation and spray foam within the wall cavity.

The above example is merely representative. Other sizes of engineered structural members embodying the present invention, such as 2×8s, may be formed using appropriately sized flanges, webs and optionally inter-flange insulating material such as rigid foam or spray foam material. Further, the present invention is not limited to a single web member between flanges, but may include multiple webs and additional insulation between the webs. Moreover, the present invention is not limited to flanges and/or webs produced solely by cutting apart dimensional lumber or otherwise homogeneous wood, but may be produced from other materials such as plywood, osb, and/or engineered lumber.

The present invention's engineered structural member has many applications, including use as sill plates, headers, cripples, jacks studs, splines, columns, etc., and may be used wherever equivalent-sized solid lumber is used. For example, appropriately arranged, the inventive structural member may be used to form a continuous insulated “thermal break” within a wall cavity. Those familiar with structure construction will recognize that there will be other applications in which the engineered structural member may be used to replace conventional lumber. For example, depending on the application, different sizes of engineered structural members may be used together, such as using 2×6 vertical studs with a nominal 4×6 header or sill plate where additional load capacity is desired. Different lengths may also be used, including lengths that are standard in the industry such as 8-foot, 9-foot and 10-foot lengths, as well as extended (e.g., 22-foot) or shorter lengths.

The present invention is not limited to being sized to correspond to nominal size lumber, but may be constructed to any desired width and depth combination which meets a desired application, such as a wall with a desired custom depth.

In another embodiment of the present invention, the web between the flanges may be non-continuous. For example, relatively short web sections may be spaced apart from one another along the length of the engineered structural member, thereby further reducing weight and material cost, with only a small, or even no, reduction in structural strength.

A further embodiment uses conventional nail plates, i.e., reinforcing metal plates that are installed alongside joints to increase the joint's strength, in place of the web or web sections. As which the previous embodiment, insulation also may be added in the gaps between nail plates to increase the effectiveness of the thermal break.

In another embodiment of the present invention, multiple webs may be used to link multiple flanges, for example, to create an extended in-line structural panel or to create a structural member with flanges at an angle to one another to form a portion of, or a complete, column member. Examples, of which angled structural members include, but are not limited to, an “L”-shaped corner, a square column or a hexagonal column.

The present invention thus provides the wood framed construction industry a lighter, more dimensionally stable alternative to solid wood framed wall construction, while still being able to meet code-required continuous insulation values by providing a continuous insulated thermal break within a wall cavity. This engineered structural member further is compatible with any type of insulation within the wall cavity, and has insulation performance that permits avoiding the disadvantages associated with the use of spray foam insulation within a wall cavity.

Other objects, advantages and novel features of the present invention will become apparent from the following detailed description of the invention when considered in conjunction with the accompanying drawings.

### BRIEF DESCRIPTION OF THE DRAWINGS

FIGS. 1A and 1B show an engineered structural member in accordance with an embodiment of the present invention.

FIG. 2 shows dimensions of a wood block from which the flanges of FIGS. 1A and 1B may be produced in accordance with the present invention.

FIG. 3 shows a wall structure constructed with the engineered structural member of FIG. 1.

FIG. 4 shows another embodiment of an engineered structural member in accordance with an embodiment of the present invention.

FIG. 5 shows another embodiment of an engineered structural member in accordance with an embodiment of the present invention.

FIGS. 6A and 6B show another embodiment of an engineered structural member in accordance with an embodiment of the present invention.

FIG. 7 shows a flow chart of a method of production of an engineered structural member in accordance with an embodiment of the present invention.

FIG. 8 shows an engineered structural member production mold in accordance with an embodiment of the present invention.

FIG. 9 shows a multi-cavity molding machine in accordance with an embodiment of the present invention.

### DETAILED DESCRIPTION

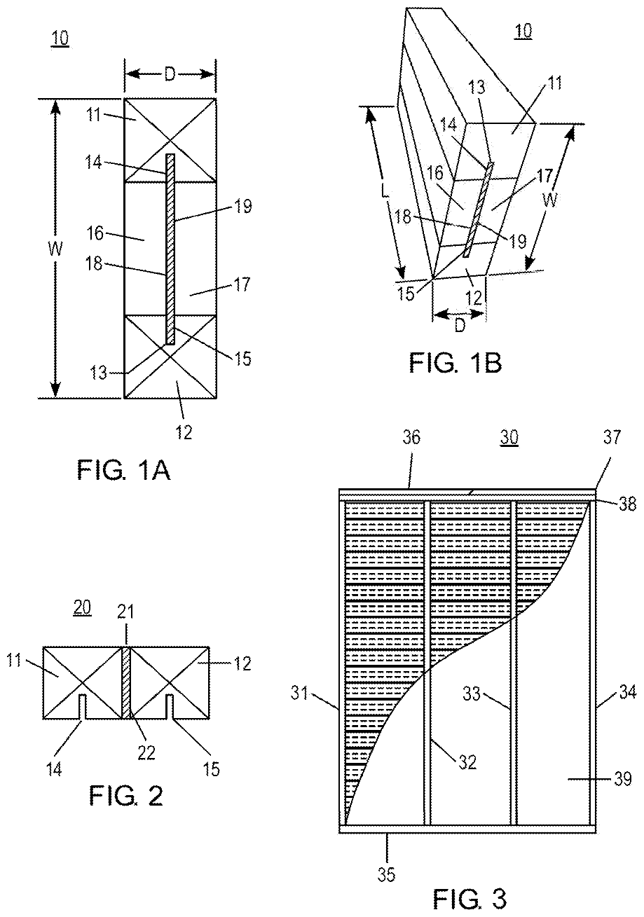

FIGS. 1A and 1B shows illustrations of a cross-section and perspective views, respectively, of an embodiment of the present invention referred to as Insul-Stud™. Both of these views show a nominal 2×6 stud having a width W of 5.5 inches and a depth D of 1.5 inches. The length L of the engineered structural member may be as needed, for example, a standard length of 8 feet, or a length to suit a particular application.

The assembled engineered structural member 10 includes flanges 11, 12, a web 13 engaged in slots 14, 15 in the flanges 11, 12, and insulation elements 16, 17 spanning the open spaces (“bays”) between the opposing faces of the flanges 11, 12 on the exposed faces 18, 19 of the web 13. At a nominal 2×6 lumber size, the engineered structural member uses approximately 40% less wood than a solid 2×6 piece of lumber of equivalent length. The engineered structural member may be used for vertical wall studs, headers and footers. Other materials with sizes and strength characteristics at least as satisfactory as wood may be used with, or in place of, lumber.

In this embodiment, the slots 14, 15 have a depth of 0.5 inches and a width of 0.125 inches. The web 13 has a width of 3.5 inches. The combination of the two 1.5 inch flanges 11, 12, the two 0.5 inch deep slots 14, 15, and the 3.5 inch web 13 result in an assembled structure with the nominal dimensions of a 2×6 (i.e., 1.5 inches by 3.5 inches) and a gap 2.5 inches wide between the flanges.

An efficient and cost-effective approach to producing the flanges 11, 12 in this embodiment is shown the cross-section view in FIG. 2. A solid piece of 2×4 lumber 20 (having nominal dimensions of 1.5 inches by 3.5 inches) may be rip-cut along the center 21 of its 3.5″ dimension to create the two flanges 11, 12. In this embodiment the flanges are symmetrical, however non-symmetrical shapes may be generated as long as the final assembled engineered structural member is dimensioned as needed by the intended application.

If the kerf 22 of the saw blade cut is 0.125 inches width, the resulting dimensions of the flanges 11, 12 are 1.5 inches wide by 1.6875 inches deep ((3.5″-0.125″)/2). Also shown in FIG. 2 are the 0.5 inch deep, 0.125 inch wide slots 14, 15 cut into the flanges 11, 12 to accommodate the opposite edges of the web 13. In this embodiment the slots 14, 15 are cut at the center of the respective 1.6875 inch deep flange sides, but they may be placed off-center in these flange sides to produce asymmetric spaces between the flanges. The slots 14, 15 may alternatively be cut into the base 2×4 lumber before, or simultaneously with, the cutting of the 2×4 into the two flanges 11, 12.

Preferably, during assembly of the engineered structural member an adhesive, preferably waterproof, is placed into the slots 14, 15 and/or onto the opposing edges of the web 13 before or during the insertion of the web 13 into the slots. The assembled structural member may be clamped during curing of the adhesive to ensure consistent dimensions of the assembled member (i.e., avoiding one flange being slightly rotated about its longitudinal axis relative to the other flange), or alternatively may be left to cure without support if the resulting product is dimensionally suitable for the intended application. Optionally, heat may be used to enhance the adhesive curing process. Once cured, the engineered structural member is ready for any necessary precision dimensioning such as length trimming, then packaging and shipment. Alternatively or in addition, the web may be secured in the slots by mechanical fasteners such as nails, staples, screws, etc.

The materials of the inventive engineered structural member may include, for the flanges, specially-source lumber of suitable species and/or grade for the intended application. For example, visually graded douglas fir larch #2 may be desirable for cost, cutting ease and/or load capacity reasons.

The web member is preferably a thin sheet material with minimal weight but sufficient rigidity to support the opposing flanges at least until the engineered structural member is incorporated into a structure such as a wall. For example, lightweight, extrusion-coated cellulosic fiber boards may provide high strength, durability and superior moisture resistance compared to plywood where the strength characteristics of plywood are not needed, while being composed of fibers with ecologically-friendly post-consumer recycled content (e.g., 94% recycled content).

In embodiments in which additional insulation is to be located between the flanges at the exposed sides of the web, a preferred insulation material is ¾″×2-½″ XPS rigid foam, having an insulating value of 12.5. Other forms of lightweight insulating material may be used without departing from the present invention. Preferably the insulating material is adhered to the web and/or flanges with a waterproof adhesive, so that the insulation remains in place during handling and subsequent in-place service.

The adhesive used to bond the flanges and web together preferably is a liquid phenol-resorcinol resin adhesive, which is a two-part system which provides a waterproof, strong structural bond. For example, Aerodux 185® with HRP 155® hardener, when fully cured, is resistant to acids, weak alkalis, solvents and boiling water. Aerodux 185® is also suitable for bonding a wide range of materials to porous substrates, including wood (including improved or densified woods), mineral fiber reinforced boards, brick, concrete, unglazed porcelain, rigid expanded plastics (e.g., expanded polystyrene, polyurethane, PVC), industrial and decorative laminates (phenolic resin-based or phenolic resin backed), leather, cork, linoleum and nylon.

FIG. 3 illustrates an embodiment of a wall structure constructed with the engineered structural member described above. This wall structure may be built in-situ, or may be provided as preassembled modular panels to increase worksite construction efficiency. In this wall structure 30 four vertical Insul-Stud™ members 31-34 are arranged on an Insul-Stud™ footer 35 and linked at their upper ends by a double-header 36 formed from two Insul-Stud™ engineered structural members 37, 38. In addition to the insulation in the bays of the Insul-Studs™, in this wall embodiment the space between the vertical Insul-Stud™ members 31-34 are filled with additional insulation material, here a compression-fit R19 kraft-faced batt fiberglass insulation, with the kraft faces being arranged toward a covering drywall sheet 39. If the wall structure is a preassembled panel, the drywall sheet may be affixed to the Insul-Stud™ members by any suitable technique, such as by the use of staples such as Senco® P19AB staples. Optionally, an opposite covering panel such as an oriented stranded board (“OSB”) sheathing may be similarly stapled or otherwise adhered to the wall structure 30. Also optionally, an air sealing caulk my be applied in a continuous bead at the double-header 36 to block air infiltration.

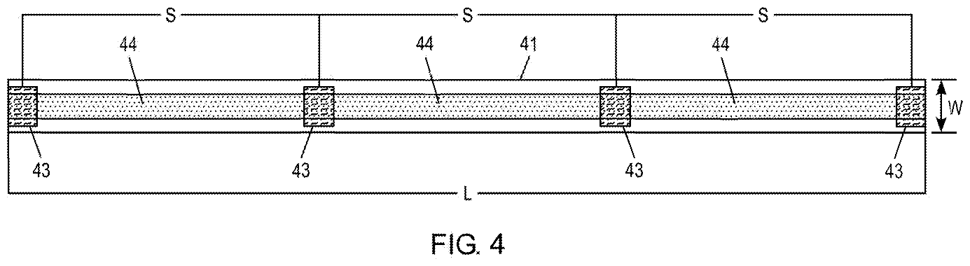

FIG. 4 shows a schematic illustration of an engineered structural member 40 in which the web between the opposing flanges 41, 42 is not continuous, but instead includes multiple short sections of webs 43 which engage the flanges' slots in a spaced-apart arrangement. The web sections may be formed from the fiber-based materials discussed above, or from metal or a plastic material which provides sufficient structural rigidity to the member. This embodiment the web sections 43 are standard 4×3 nail plates. Insulation material 44 is arranged between the web sections 43 to enhance the thermal break effect.

The FIG. 4 engineered structural member 40 has the nominal dimensions of a 2×6 by 8-foot piece of lumber, having a 1.5 inch depth (into the plane of the page), a 5.5 inch width W, and the web sections 43 at a 31 inch center-to center spacing S.

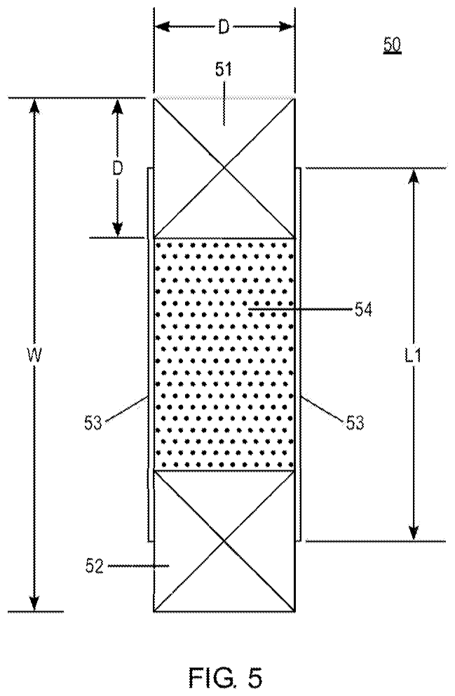

Alternatively, FIG. 5 shows an embodiment of a 2×6 engineered structural member 50 in which 4 inch×3 inch nail plates 53 are affixed to the sides of the flanges 51, 52. The flanges 51, 52 in this embodiment are conventional 2×2 lumber, having depth and width dimensions of 1.5 inches by 1.5 inches. With the ends of the nail plates centered over the centers of the flanges 51, 52, a nominal 6 inch width W (4+0.75+0.75=5.5 inches) structure is formed. Within the 3.5 inch space between the flanges 51, 52 created by the 4 inch length L1 of the nail plate 53, insulation material such as 1.5 inch thick XPS foam may be installed to enhance the effectiveness of the thermal break structure. Due to the relatively thin dimension of the nail plates, the nominal 1.5-inch depth D of the nominal 2 inch dimension of the 2×6 remains substantially unchanged. This embodiment is particularly well-suited to applications in which the structural members will not be in contact with one another across their width faces, so that the thickness of the nail plates is of no consequence to the overall structure. In some embodiments in which the insulation between the flanges 51, 52 is of sufficient rigidity and is sufficiently adhered to the flanges, the nail plates shown in FIG. 5 may be dispensed with.

Previously, insulating foams have been considered by those in the art of building structural members to be non-structural materials, i.e., materials that could not provide any significant load-bearing function due to the foams being too brittle or too flexible to withstand significant compression, shear, tension and/or bending loads, such as might be experienced during transport to a jobsite, preparation for installation (e.g., handling when being cut to length on-site or hammered into position to fit a slightly-too-long member long into place), and/or in-situ load-bearing. Further, maintaining sufficient adhesion of previous foams to wood under stress has been problematic, both during transport and over the installed life of the member. Moreover, pourable foam technology has not previously been considered in the present application due to cost, need for specialty equipment, and lack of a commercially efficient manufacturing process.

The inventor has determined that a particular type of a two-part polyurethane foam system has the strength, resilience, adhesion and other properties which make it suitable for use in an engineered structural member, despite the prior expectation in the art that insulating foams were not suitable for use in an engineered structural member without the presence of other load-bearing supports, such as dowels extending between opposing wood flange members. For example, when an engineered structural member in accordance with the present invention is loaded in a direction perpendicular to its longitudinal axis, the load-bearing capacity of the engineered structural member is increased by the linkage of the spaced-apart flanges by the two-part polyurethane foam system.

An engineered structural member which does not require load-bearing supports bridging its outer flanges also has the benefit of providing a highly thermally efficient approach to meeting emerging industry building insulation standards, such as the 2021 change in the International Energy Conservation Code (“IECC”) which now requires continuous insulation in new residential construction throughout a majority of the country. The two-part polyurethane foam system also provides a cost effective solution to ensuring the required insulation within the wall cavity is present, without a need for additional materials applied on the exterior of the building.

An example of such a two-part polyurethane foam system is available from Dow Polyurethanes™, an affiliate of The Dow Chemical Company™, in the form of a mixture of Dow VORACOR™ CD 2105 Polyol and VORACOR™ CE 108 Isocyanate formed in a high-pressure mixing process. The VORACOR™ CD 2105 polyol is a fully formulated polyol system containing a hydrofluoroolefin (HFO) physical blowing agent 1233zd, to be used in high density pour-in-place applications. The cured two-part polyurethane foam system has sufficient rigidity, resiliency, density, insulation capability, fire behavior and adhesion to wood products in sizes in the range of typical construction wood products (e.g., 2×4, 2×6, 2×10, 4×4) to overcome the problems of previous foam materials. In some embodiments the VORACOR™ CD 2105 Polyol and VORACOR™ CE 108 Isocyanate components are mixed in a ratio of approximately 1:2 to 2:1.

For example, once this material is densified and cured, the result is a material having a density on the order of 5 pounds per cubic foot, a fire behavior under Underwriters Labs protocol UL 723 of 17 flame spread and 400-450 smoke at a 4-inch thickness, a K-factor at 75° F. of 0.156±0.002 Btu*in/ft² h ° F., and a shear strength on the order of 60 psi or more. In one embodiment of a FIG. 5 2×6 application, application of this insulating material directly to 10-foot long examples of flanges 51, 52 resulted in a structural member which can withstand a vertical load of 3,500 lbs. or more and a bending moment of 900 ft.-lb. or more. Other testing included tests of 8-foot long versions of the FIG. 5 2×6 structural member, included direct application of a bending load in the direction of the member's nominal 6-inch width. The use of the VORACOR™ CD 2105 Polyol and VORACOR™ CE 108 Isocyanate material in the structural member, resulted in structural members which were able to withstand bending loads in the range of 1,000-1,200 lb. and lateral deflection approximately 2-4 inches before the VORACOR™ CD 2105 Polyol and VORACOR™ CE 108 Isocyanate material showed signs the connection between the foam and the flanges beginning to separate toward the outer ends of the structural member in response to the applied shear loading.

The use of the VORACOR™ CD 2105 Polyol and VORACOR™ CE 108 Isocyanate material has the advantages of improving thermal insulation performance of the structural member by eliminating heat-conducting “short circuits” along the flange-spanning webs or outer support plates, lowering material costs by eliminating the need for webs and/or outer plates spanning between the flanges (and, in the case of use of the outer metal plates, the need for fasteners such as nails), and reducing the number of flange machining operations (e.g., eliminating the need to cut longitudinal slots in the flanges).

The engineered structural member with the FIG. 5 core configuration (i.e., not needing outer support plates) may be manufactured in multiple ways. For example, the VORACOR™ CD 2105 Polyol and VORACOR™ CE 108 Isocyanate material may be initially mixed in a high pressure foam machine such as a Hydra 20 model machine available from Foam Supplies, Inc. of Earth City, Mo. A Hydra 20 mixing machine is capable of operating at a working pressure of up to 200 Bar, while also supplying up to 1500 W of additional heat to facilitate the mixing of the foam components.

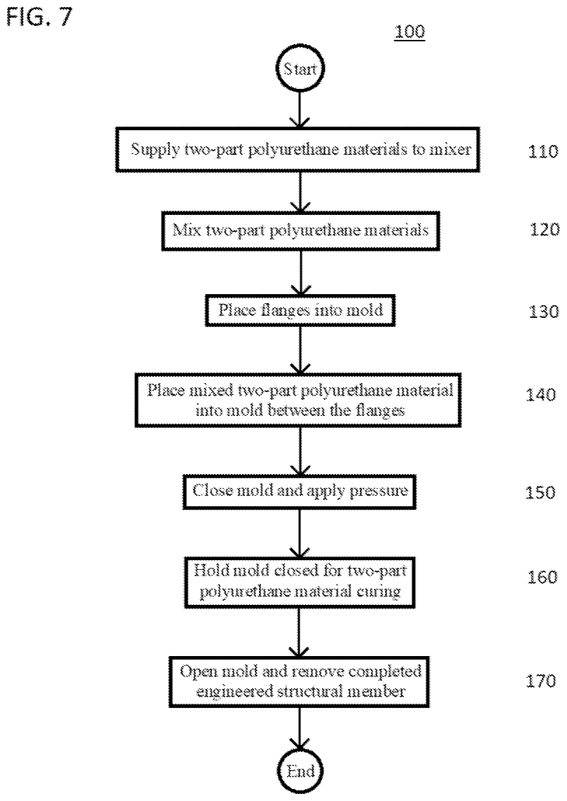

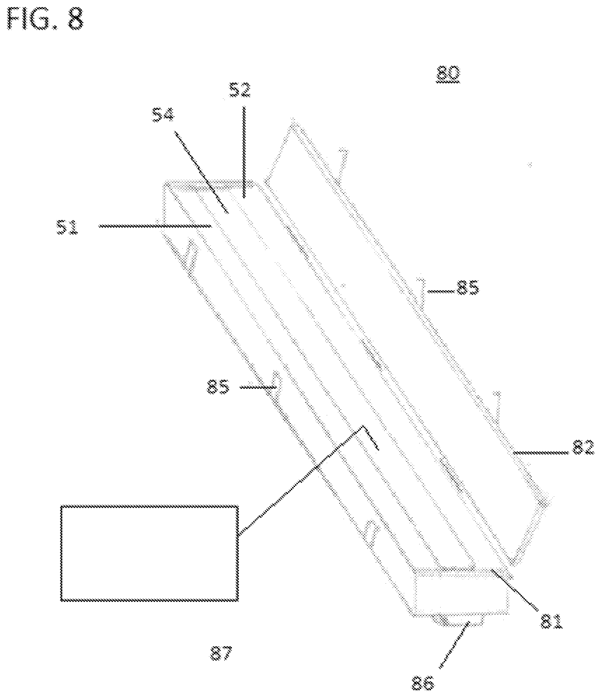

FIG. 7 shows a flow chart 100 of the steps of an embodiment of a method for forming a structural member using the VORACOR™ CD 2105 Polyol and VORACOR™ CE 108 Isocyanate material in a mold such as that shown in FIG. 8. FIG. 8 schematically illustrates a mold 80 having been opened upon curing of the VORACOR™ CD 2105 Polyol and VORACOR™ CE 108 Isocyanate material. The mold 80 includes a mold cavity 81 and a mold cover 82, with the cured material 54 between two flanges 51, 52. Also schematically illustrated are components of latches 85 and a pressure applicator 86, for example, an inflatable air chamber which bears against a bottom side of the mold to constrain expansion of the VORACOR™ CD 2105 Polyol and VORACOR™ CE 108 Isocyanate material during curing.

At step 110 of FIG. 7, the VORACOR™ CD 2105 Polyol and VORACOR™ CE 108 Isocyanate material are supplied to mixing unit 87, which at step 120 mixes these chemicals at elevated temperature, for example at 80°-90° F. At step 130 wood flange members 51, 52 are placed in the mold 80 at a predetermined spacing, followed in step 140 by either placement or injection of the mixed and heated VORACOR™ CD 2105 Polyol and VORACOR™ CE 108 Isocyanate material 54 into the space in the mold cavity 81 between the wood flanges 51, 52. For example, a predetermined amount of the heated VORACOR™ CD 2105 Polyol and VORACOR™ CE 108 Isocyanate material (for example, liters in an eight ft. long mold cavity) may be placed into the mold and then the mold cover 82 closed and secured by latches 85 in a pressure-tight manner. Alternatively, the mold cover 82 may be closed and then the VORACOR™ CD 2105 Polyol and VORACOR™ CE 108 Isocyanate material injected under pressure to fill the space between the wood flanges.

After closing of the mold, at step 150 the mold is closed and pressure is applied at a pressure of approximately 40-60 psi, using a pressure applicator 86, for example, hydraulic clamps and/or pneumatic elements such as air bag(s), to confine the foam material as it expands and densifies to a density of at least approximately 5 lb./ft³ to approximately 10 lb./ft³. The shape of the mold cavity and the constraints on the VORACOR™ CD 2105 Polyol and VORACOR™ CE 108 Isocyanate material's expansion controls the dimensions of the engineered structural member to a target cross-sectional width and height. In this embodiment of the production method, the inserted two-part polyurethane foam system material solidifies in step 160 with the aid of mold heating at approximately 115° F. Once the VORACOR™ CD 2105 Polyol and VORACOR™ CE 108 Isocyanate material has cured to the point of being tack-free (approximately three minutes or more, in part depending on the amount of additional heating provided to the mold cavity during curing), the mold is opened and the fully-formed engineered structural member is removed from the mold in step 170, ready for preparation for shipment. In this particular embodiment, the mold is configured to form a 1.625″×5.5″ non-dimensional thermal break wood and structural foam stud from two lumber 1.625″×1.5″ flanges, with the structural foam insulation having a 1.625″ width×2.5″ depth dimensions between the wood flanges.

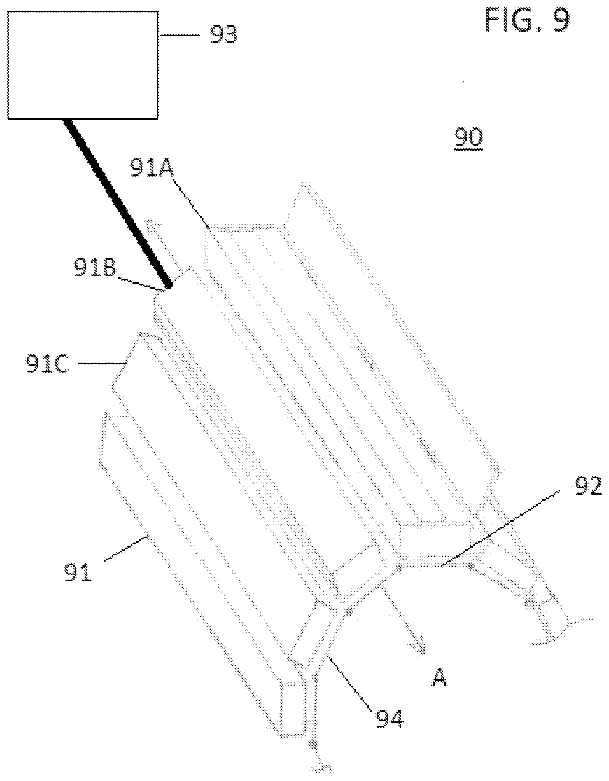

A particularly advantageous embodiment provides an apparatus which permits at least semi-continuous forming of the inventive structural member. An example is shown in FIG. 9, in which a barrel-shaped rotary mold arrangement 90 includes a plurality of molds 91 which rotate about a central axis A. Such an arrangement permits placement of flanges 51, 52 and the appropriate amount of the two-part polyurethane foam system 54 in one mold 91A, closure of the mold and application of pressure, followed by with the mold 91A then slowly rotating around (continuously or in steps) while the foam therein cures enough to permit removal of the completed structural member when the mold 91A rotates back into an accessible position. While the foam is curing in the first mold 91A, subsequent molds 91B, 91C, etc. in turn rotate to the mold-filing position 84, are filled and closed. The molds may return to the filling position 84 for removal of a cured structural member before the mold is refilled. Alternatively, the cured structural members may be removed from their respective molds 91 at a point before the mold returns to the filling position 92, so that the mold is empty and ready to be immediately filled without having to wait for a completed structural member to be removed at the filling position 92. Rotary mold arrangement is driven to rotate about axis A a rotary drive unit 93 which drives a rotary carriage 94 (both schematically-illustrated).

In one embodiment, initial preparation of a mold cavity with a foam release material, and dispensing of the two-part polyurethane foam into the cavity may be accomplished in approximately 1-2 minutes, followed by closure of the mold lid and application of pressure. In an example molding machine with 14 mold cavities, the cycle time of each mold chamber may be on the order of 20 minutes by the time a mold returns to the mold filling position. This timing is adequate to ensure the two-part polyurethane foam has had sufficient time to set enough to permit removal from the mold and further handling by the time the mold machine completes a full rotation. Such an approach to semi-continuous or continuous production arrangement may significantly improve the rate of production of the inventive structure members, and avoid the need for use of an excessive amount of production floor space.

An alternative multiple-mold arrangement may include a plurality of mold cavities being conveyed on a linear path with molds being provided with flange members and two-part polyurethane material in a sequential manner. Molding of multiple structural members at one time may be accomplished in other manners, such as simultaneous filing and closure of a “gang” of multiple mold cavities. The filling of the molds also is not required to be completed in a strictly sequential manner. For example, one or more molds may be skipped during movement of the multiple molds if desired to alter the curing time (e.g., to permit a mold to make more than one revolution to increase curing time in a small-diameter rotary molding machine) and/or alter the rate of production of the structural members.

In a further embodiment, the engineered structural member may be produced in a continuous production process in which flanges and the two-part polyurethane material are continuously suppled to a continuous mold cavity, for example, by using flanges having finger-grooves at their ends to facilitate formation of a continuous flow of flanges into the mold cavity. At the output side of such a continuous process, the completed structure may be cut to any desired length for subsequent handling and use.

As an alternative or in addition to heating of the VORACOR™ CD 2105 Polyol and VORACOR™ CE 108 Isocyanate material in the high-pressure mixing machine, the material may be heated in-situ after injection in the mold to increase the cure rate of the VORACOR™ CD 2105 Polyol and VORACOR™ CE 108 Isocyanate material. For example, the engineered structural member may be heated by heating elements incorporated into the molds, or alternatively passing through a region which applies external heat to the mold.

One of ordinary skill in the art will recognize that the present invention is not limited to the VORACOR™ CD 2105 Polyol and VORACOR™ CE 108 Isocyanate material, but that an engineered structural member formed with a foam material with similar rigidity, resiliency and adhesion properties, either currently known or later developed, would be within the scope of the present invention.

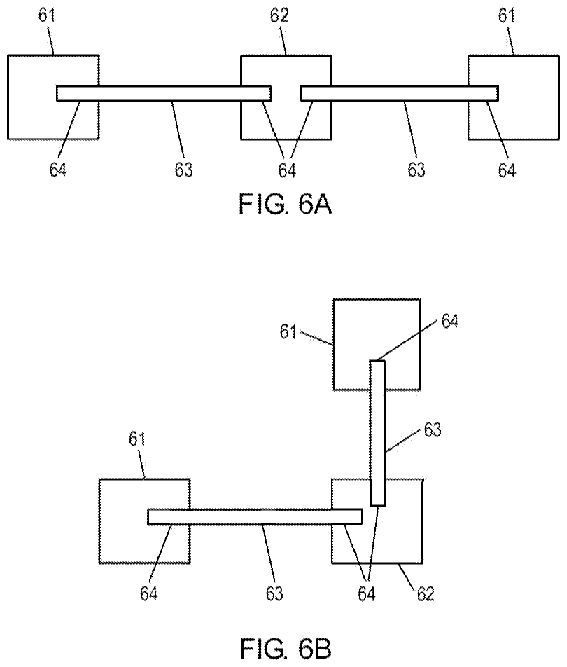

FIGS. 6A and 6B show embodiments of the present invention composed of more than two flange members. FIG. 6A shows an engineered structural panel 60 having three flange members 61, 62. The two flange members 61 each have a single slot 64 to receive a web 63, and the third flange member 62 has two slots on opposite faces. The webs 63 are aligned parallel to one another. In FIG. 6B, the third flange member 63 has its two slots at adjacent faces, resulting in this embodiment having a 90° column structure. Alternatively, the slots in the third flange member 62 may be arranged such that the webs members 64 are arranged at any angle between 0°-180°. The present invention is not limited to three flange members, but may include multiple flange members and corresponding webs which extend the engineered structural member to a desired extent, either linearly or in a curved extent, up to and including a closed structure in the form of a light-weight, hollow column.

The foregoing disclosure has been set forth merely to illustrate the invention and is not intended to be limiting. Because such modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

10 engineered structural member
11, 12 flanges
13 web
14, 15 slots
16, 17 insulation
18, 19 web faces
20 lumber
21 center
22 saw blade kerf
30 wall structure
31-34 engineered structural members
35 footer, aka sill plate
36 double-header
37, 38 engineered structural members
39 drywall sheet
40 engineered structural member
41, 42 flanges
43 web sections
44 insulation
50 engineered structural member
51, 52 flanges
53 web sections
54 insulation
61, 62 flanges
62 webs
64 slots
80 mold arrangement
81 mold cavity
82 mold cover
85 latches
86 pressure applicator
87 mixing unit
90 rotary mold arrangement
91 molds
92 mold filling position
93 rotary drive unit
94 rotary carriage
A rotation axis
D depth
W width
L length
L1 nail plate length
S spacing

What is claimed is:

1. A structural member, comprising:
two flange members spaced apart from one another a predetermined distance; and
an insulation material arranged in a space between the spaced-apart flange members,
wherein
the insulation material adheres to each of the two flange members, and
the insulation material has a density of at least 5 lb./ft³.

2. The structural member of claim 1, wherein the insulation material is a two-part polyurethane material.

3. The structural member of claim 2, wherein the two-part polyurethane material is a mixture of VORACOR™ CD 2105 Polyol and VORACOR™ CE 108 Isocyanate materials.

4. The structural member of claim 3, wherein a ratio of the VORACOR™ CD 2105 Polyol and VORACOR™ CE 108 Isocyanate materials is 1:2 to 2:1.

5. The structural member of claim 4, wherein the structural member is capable of withstanding a bending load of at least 1,000 lb. applied to an eight foot-long portion of the structural member in a direction passing through a first one of the two flange members, then through the insulation material, and then through the second one of the two flange members.

6. The structural member of claim 1, wherein the structural member is capable of withstanding a bending load of at least 1,000 lb. applied to an eight foot-long portion of the structural member in a direction passing through a first one of the two flange members, then through the insulation material, and then through the second one of the two flange members.

7. The structural member of claim 4, wherein the structural member is capable of withstanding a compressive load along a longitudinal axis of the structural member of 3,500 lbs. or more.

8. The structural member of claim 1, wherein the structural member is capable of withstanding a compressive load along a longitudinal axis of the structural member of 3,500 lbs. or more.

9. The structural member of claim 4, wherein the structural member is capable of withstanding a bending moment of 900 ft.-lbs. or

10. The structural member of claim 1, wherein the structural member is capable of withstanding a bending moment of 900 ft.-lbs. or

11. A method of manufacture of a structural member, comprising the steps of:
mixing a two-part polyurethane material;
inserting two flange members spaced apart from one another a predetermined distance in a mold cavity of a mold located at a mold filling position;
inserting the two-part polyurethane material into a cavity between the two spaced-apart flange members;
closing the mold around the two flange members and the two-part polyurethane material;
after the two-part polyurethane material has cured into at least a tack-free state, removing the molded structural member from the mold cavity.

12. The method of claim 11, wherein the two-part polyurethane material is a mixture of VORACOR™ CD 2105 Polyol and VORACOR™ CE 108 Isocyanate materials.

13. The method of claim 12, further comprising the step of:
after closing the mold, applying pressure against the two-part polyurethane material while the two-part polyurethane material densifies.

14. The method of claim 13, wherein the pressure applied against the two-part polyurethane material is in the range of 40-60 psi.

15. The method of claim 13, further comprising the step of:
after closing the mold, applying heat from the mold to the two-part polyurethane material.

16. The method of claim 13, wherein the heat applied from the mold to the two-part polyurethane material is sufficient to obtain a temperature of 115° F. in at least a portion of the two-part polyurethane material.

17. The method of claim 11, further comprising the steps of:
providing a molding machine in which the mold is a first one of a plurality of molds;
after closing the first mold, moving the first mold out of the mold filling position;
moving a second one of the plurality of molds into the mold filling position;
repeating the inserting and closing steps using the second mold.

18. The method of claim 17, wherein the moving, inserting and closing steps are repeated with the remaining ones of the plurality of molds.

19. The method of claim 18, wherein the molding machine is a rotary molding machine.

20. The method of claim 19, wherein the step of removing the structural member is performed at the filling position after completing at least one rotation around the rotary molding machine.

21. The method of claim 11, wherein the molding machine is a gang-molding machine in which the inserting and closing steps are repeated in parallel with multiple ones of the plurality of molds.
